(19) United States
(12) Patent Application Publication
(10) Pub. No.: US 2007/0139572 A1
(43) Pub. Date: Jun. 21, 2007

(54) THIN FILM TRANSISTOR ARRAY PANEL FOR LIQUID CRYSTAL DISPLAY AND MANUFACTURING METHOD THEREOF

(76) Inventor: Young-Wook LEE, Suwon-si (KR)

Correspondence Address: Frank Chau, Esq.;F. CHAU & ASSOCIATES, LLC, 130 Woodbury Road, Woodbury, NY, 11797, US

(21) Appl. No.: 11/609,144

(22) Filed: Dec. 11, 2006

(30) Foreign Application Priority Data
Dec. 16, 2005 (KR) 10-2005-0124428

(51) Int. Cl. G02F 1/136

(52) U.S. Cl. 349/43

(57) ABSTRACT

A thin film transistor array panel includes a substrate, a gate line disposed on the substrate, a gate insulating layer disposed on the gate line, a semiconductor layer disposed on the gate insulating layer, a data line contacting the semiconductor layer, a drain electrode contacting the semiconductor layer and separated from the data line, a pixel electrode disposed on the gate insulating layer and contacting the drain electrode, a passivation layer disposed on the pixel electrode, and a common electrode disposed on the passivation layer and including a unit electrode overlapping the pixel electrode.

### CROSS-REFERENCE TO RELATED PATENT APPLICATION

This application claims priority to Korean Patent Application No. 10-2005-0124428, filed on Dec. 16, 2005, the disclosure of which is incorporated by reference herein in its entirety.

### BACKGROUND OF THE INVENTION

(a) Technical Field

The present invention relates to a thin film transistor array panel and a manufacturing method thereof, and in particular, to a thin film transistor array panel for a liquid crystal display and a manufacturing method thereof.

(b) Discussion of Related Art

A liquid crystal display (LCD) is one of the most widely used flat panel displays. An LCD may include two panels provided with field-generating electrodes, such as pixel electrodes and a common electrode, and a liquid crystal (LC) layer interposed therebetween. The LCD displays images by applying voltages to the field-generating electrodes to generate an electric field in the LC layer, which determines orientations of LC molecules in the LC layer to adjust polarization of incident light.

An LCD may have a narrow reference viewing angle due to the refractive anisotropy of the liquid crystal.

In order to widen the narrow viewing angle, various types of LCDs, such as a patterned vertically aligned (PVA) mode LCD, an in-plane-switching mode LCD, and a plane-to-line switching mode LCD, have been suggested.

An LCD that has a high aperture ratio, a low driving voltage, and less defects, such as unexpected disconnections and short-circuits of signal lines, is desired.

### SUMMARY OF THE INVENTION

A thin film transistor array panel according to an embodiment of the present invention includes a substrate, a gate line disposed on the substrate, a gate insulating layer disposed on the gate line, a semiconductor layer disposed on the gate insulating layer, a data line contacting the semiconductor layer, a drain electrode contacting the semiconductor layer and separated from the data line, a pixel electrode disposed on the gate insulating layer and contacting the drain electrode, a passivation layer disposed on the pixel electrode, and a common electrode disposed on the passivation layer and including a unit electrode overlapping the pixel electrode.

The pixel electrode and the common electrode may be substantially transparent.

The pixel electrode and the unit electrode may generate an electric field having a horizontal component and a vertical component.

The unit electrode may have a plurality of cutouts exposing the pixel electrode.

The pixel electrode may have a shape of a plane having no openings therein.

The cutouts of the unit electrode may fully overlap the pixel electrode.

The cutouts of the unit electrode may make oblique angles with the gate line. The cutouts of the unit electrode may be arranged symmetrical with respect to a straight line substantially parallel to the gate line and bisecting the pixel electrode.

The thin film transistor array panel may further include a subsidiary line contacting the data line and separated from the pixel electrode.

The subsidiary line may be formed from the same layer as the pixel electrode.

The common electrode may further include a connecting portion connected to the unit electrode and intersecting at least one of the gate line and the data line.

The thin film transistor array panel may further include a common voltage line formed from the same layer as the gate line or the data line and electrically connected to the common electrode.

A method of manufacturing a thin film transistor array panel according to an embodiment of the present invention includes forming a gate line on a substrate, forming a gate insulating layer on the gate line, forming a semiconductor layer on the gate insulating layer, forming a data line and a drain electrode on the gate insulating layer and the semiconductor layer, forming a pixel electrode on the drain electrode and the gate insulating layer, forming a passivation layer on the pixel electrode, and forming a common electrode on the passivation layer.

The passivation layer may have a thickness of about 1,500 Å to about 2,500 Å.

The method may further include forming a common voltage line connected to the common electrode, wherein the common voltage line and the gate line are simultaneously formed.

The method may further include forming a subsidiary line on the data line, wherein the subsidiary line and the pixel electrode are simultaneously formed.

The common electrode may have a plurality of cutouts exposing the pixel electrode.

### BRIEF DESCRIPTION OF THE DRAWINGS

Exemplary embodiments of the present invention can be understood in more detail with reference to the accompanying drawings, in which:

FIG. 1 is a layout view of a TFT array panel according to an embodiment of the present invention;

FIG. 2 is a sectional view of the TFT array panel shown in FIG. 1 taken along the line II-II;

FIG. 3 is a sectional view of the TFT array panels shown in FIG. 1 taken along the lines III-III′ and III′-III″;

FIG. 4 is a sectional view of the TFT array panel shown in FIG. 1 taken along the line IV-IV;

FIGS. 5, 7, 9, 11 and 13 are layout views of the TFT array panel shown in FIGS. 1-4 during a manufacturing method thereof according to an embodiment of the present invention;

FIG. 6A is a sectional view of the TFT array panel shown in FIG. 5 taken along the line VIA-VIA;

FIG. 6B is a sectional view of the TFT array panel shown in FIG. 5 taken along the lines VIB-VIB′ and VIB′-VIB″;

FIG. 6C is a sectional view of the TFT array panel shown in FIG. 5 taken along the line VIC-VIC;

FIG. 8A is a sectional view of the TFT array panel shown in FIG. 7 taken along the line VIIIA-VIIIA;

FIG. 8B is a sectional view of the TFT array panel shown in FIG. 7 taken along the lines VIIIB-VIIIB′ and VIIIB′-VIIIB″;

FIG. 8C is a sectional view of the TFT array panel shown in FIG. 7 taken along the line VIIIC-VIIIC;

FIG. 10A is a sectional view of the TFT array panel shown in FIG. 9 taken along the line XA-XA;

FIG. 10B is a sectional view of the TFT array panel shown in FIG. 9 taken along the lines XB-XB′ and XB′-B″;

FIG. 10C is a sectional view of the TFT array panel shown in FIG. 9 taken along the lines XC-XC;

FIG. 12A is a sectional view of the TFT array panel shown in FIG. 11 taken along the line XIIA-XIIA, respectively;

FIG. 12B is a sectional view of the TFT array panel shown in FIG. 11 taken along the lines XIIB-XIIB′ and XIIB′-XIIB″;

FIG. 12C is a sectional view of the TFT array panel shown in FIG. 11 taken along the line XIIC-XIIC;

FIG. 14A is a sectional view of the TFT array panel shown in FIG. 13 taken along the line XIVA-XIVA;

FIG. 14B is a sectional view of the TFT array panel shown in FIG. 13 taken along the lines XIVB-XIVB′ and XIVB′-XIVB″; and

FIG. 14C is a sectional view of the TFT array panel shown in FIG. 13 taken along the line XIVC-XIVC.

### DETAILED DESCRIPTION OF EMBODIMENTS

Exemplary embodiments of the present invention now will be described more fully hereinafter with reference to the accompanying drawings. This invention may, however, be embodied in many different forms and should not be construed as limited to the embodiments set forth herein. Like numerals refer to like elements throughout.

In the drawings, the thickness of layers and regions may be exaggerated for clarity. It will be understood that when an element such as a layer, region or substrate is referred to as being “on” another element, it can be directly on the other element or intervening elements may also be present.

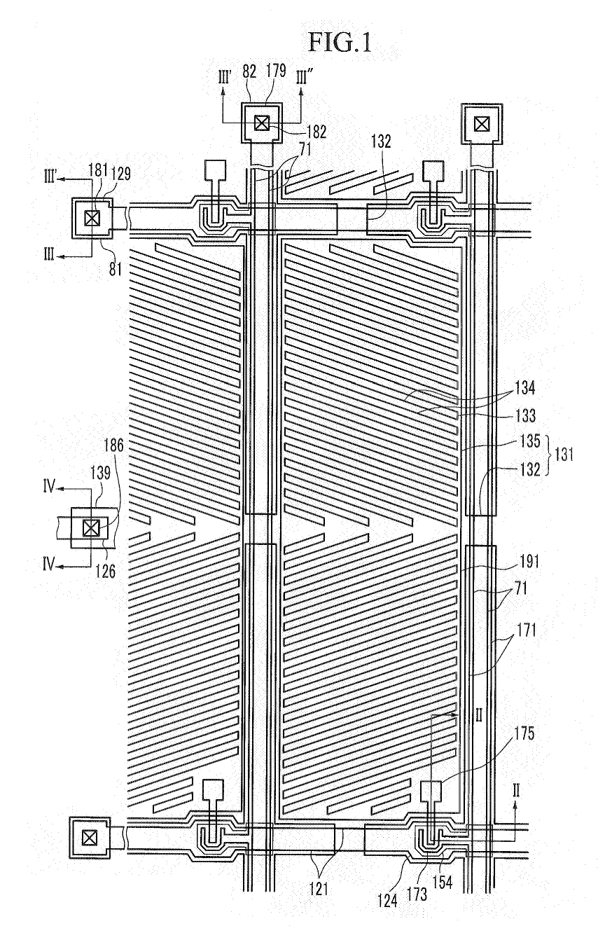

A TFT array panel for a liquid crystal display (LCD) according to an embodiment of the present invention will he described with reference to FIGS. 1, 2, 3 and 4.

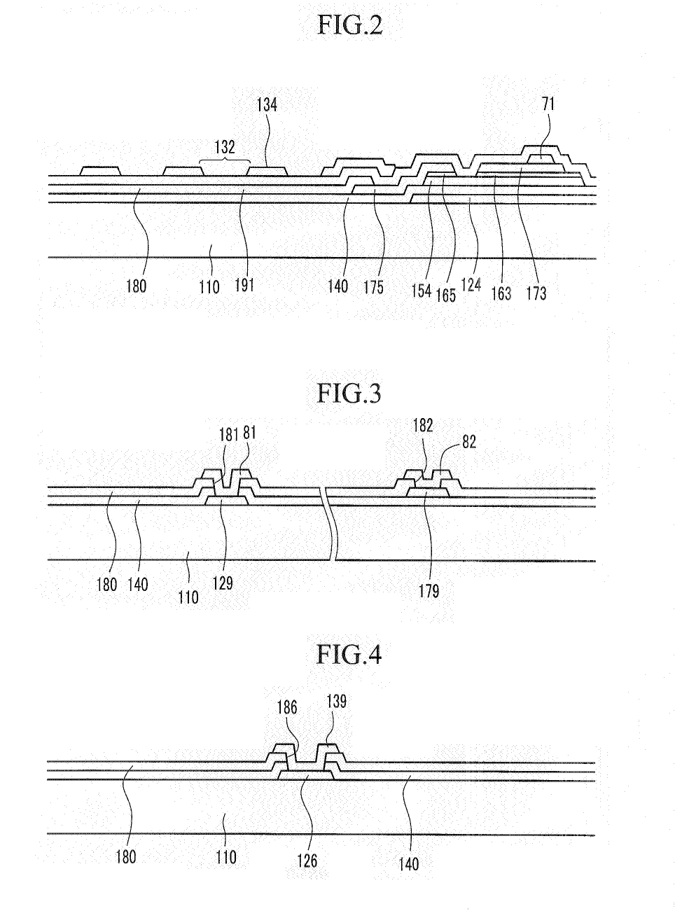

FIG. 1 is a layout view of a TFT array panel for an LCD according to an embodiment of the present invention, and FIGS. 2, 3 and 4 are sectional views of the TFT array panel shown in FIG. 1.

A plurality of gate lines 121 and a common voltage line 126 are formed on an insulating substrate 110 such as transparent glass or plastic.

The gate lines 121 transmit gate signals and extend substantially in a transverse direction. Referring, for example, to FIG. 1, each of the gate lines 121 includes a plurality of gate electrodes 124 projecting upward and downward and an end portion 129 having a large area for contact with another layer or an external driving circuit. A gate driving circuit (not shown) for generating the gate signals may be mounted on a flexible printed circuit (FPC) film (not shown), which may be attached to the substrate 110, directly mounted on the substrate 110, or integrated onto the substrate 110. The gate lines 121 may extend to be connected to a driving circuit that may be integrated on the substrate 110.

The common voltage line 126 is supplied with a common voltage and disposed near the end portions 129 of the gate lines 121. The common voltage line 126 may have an expansion for contact with another layer or an external driving circuit.

The gate lines 121 and the common voltage line 126 may be made of Al containing metal such as Al and Al alloy, Ag containing metal such as Ag and Ag alloy, Cu containing metal such as Cu and Cu alloy, Mo containing metal such as Mo and Mo alloy, Cr, Ta, or Ti. The gate lines 121 may have a multi-layered structure including two conductive films (not shown) having different physical characteristics. One of the two films may be made of low resistivity metal including, for example, Al containing metal, Ag containing metal, and Cu containing metal for reducing signal delay or voltage drop. The other film may be made of material such as Mo containing metal, Cr, Ta, or Ti, which has good physical, chemical, and electrical contact characteristics with other materials such as indium tin oxide (ITO) or indium zinc oxide (IZO). Examples of the combination of the two films are a lower Cr film and an upper Al (alloy) film and a lower Al (alloy) film and an upper Mo (alloy) film. However, it is to be understood that the gate lines 121 and the common voltage line 126 may be made of various metals or conductors.

The lateral sides of the gate lines 121 and the common voltage line 126 are inclined relative to a surface of the substrate 110, and the inclination angle thereof ranges from about 30 to about 80 degrees.

A gate insulating layer 140 made of, for example, silicon nitride (SiNx) or silicon oxide (SiOx) is formed on the gate lines 121 and the common voltage line 126.

A plurality of semiconductor islands 154 made of, for example, hydrogenated amorphous silicon (abbreviated to “a-Si”) or polysilicon are formed on the gate insulating layer 140. The semiconductor islands 154 are disposed on the gate electrodes 124 and include extensions covering boundaries of the gate lines 121.

A plurality of pairs of ohmic contact islands 163 and 165 are formed on the semiconductor islands 154. The ohmic contacts 163 and 165 are made of, for example, silicide or n+ hydrogenated a-Si heavily doped with n type impurity such as phosphorous.

The lateral sides of the semiconductor islands 154 and the ohmic contacts 163 and 165 are inclined relative to the surface of the substrate 110, and the inclination angles thereof are in a range of about 30 to about 80 degrees.

A plurality of data lines 171 and a plurality of drain electrodes 175 are formed on the ohmic contacts 163 and 165 and the gate insulating layer 140.

The data lines 171 transmit data signals and extend substantially in the longitudinal direction to intersect the gate lines 121. Referring, for example, to FIG. 1, each data line 171 includes a plurality of source electrodes 173 projecting toward the gate electrodes 124 and curved in a “U” shape and includes an end portion 179 having a large area for contact with another layer or an external driving circuit. A data driving circuit (not shown) for generating the data signals may be mounted on a FPC film (not shown), which may be attached to the substrate 110, directly mounted on the substrate 110, or integrated onto the substrate 110. The data lines 171 may extend to be connected to a driving circuit that may be integrated on the substrate 110.

The drain electrodes 175 are separated from the data lines 171 and disposed opposite the source electrodes 173 with respect to the gate electrodes 124. Each of the drain electrodes 175 includes a first end portion and a second end portion, wherein the first end portion is wider than the second end portion. The narrower second end portion is partly enclosed by a source electrode 173.

A gate electrode 124, a source electrode 173, and a drain electrode 175 along with a semiconductor island 154 form a TFT having a channel formed in the semiconductor island 154 disposed between the source electrode 173 and the drain electrode 175.

The data lines 171 and the drain electrodes 175 may be made of refractory metal such as Cr, Mo, Ta, Ti, or alloys thereof. The data lines and the drain electrodes 175 may have a multilayered structure including a refractory metal film (not shown) and a low resistivity film (not shown). Examples of the multi-layered structure are a double-layered structure including a lower Cr/Mo (alloy) film and an upper Al (alloy) film and a triple-layered structure of a lower Mo (alloy) film, an intermediate Al (alloy) film, and an upper Mo (alloy) film. However, it is to be understood that the data lines 171 and the drain electrodes 175 may be made of various metals or conductors.

The data lines 171 ad the drain electrodes 175 have inclined edge profiles, and the inclination angles thereof range from about 30 to about 80 degrees.

The ohmic contacts 163 and 165 are interposed between the underlying semiconductor islands 154 and the overlying conductors 171 and 175 thereon and reduce the contact resistance therebetween. The extensions of the semiconductor islands 154, which are disposed on the gate lines 121, smooth the profile of the surface to prevent the disconnection of the data lines 171. The semiconductor islands 154 include some exposed portions, which are not covered with the data lines 171 and the drain electrodes 175, such as portions located between the source electrodes 173 and the drain electrodes 175.

The common voltage line 126 may be made from the same layer as the data lines 171 and the drain electrodes 175.

A plurality of pixel electrodes 191 and a plurality of subsidiary data lines 71 are formed on the gate insulating layer 140, the drain electrodes 175, and the data lines 171. The pixel electrodes 191 and the subsidiary data lines 71 may be made of a transparent conductor such as ITO or IZO. Alternatively, the pixel electrodes 191 and the subsidiary data lines 71 may be made of a reflective conductor such as Ag, Al, Cr, or alloys thereof.

The pixel electrodes 191 occupy most of the areas enclosed by the gate lines 121 and the data lines 171. In accordance with an embodiment, the pixel electrodes 191 are formed in a plane shape and do not include any empty spaces or openings therein. The pixel electrodes 191 are spaced apart from the data lines 171 and the subsidiary data lines 71. The pixel electrodes 191 directly contact the drain electrodes 175 such that the pixel electrodes 191 receive data voltages from the drain electrodes 175.

The subsidiary data lines 71 contact the data lines 171 and extend along the data lines 171 such that the subsidiary data lines 71 prevent the flow of the data voltages carried by the data lines 171 from being cut off. Referring, for example, to FIG. 1, an entire subsidiary data line 71 is disposed within the boundaries the data lines 171 in a width direction. Alternatively, the subsidiary data lines 71 may cover the edges of the data lines 171.

A passivation layer 180 is formed on the pixel electrodes 191, the subsidiary data lines 71, the data lines 171, the drain electrodes 175, and the exposed portions of the semiconductor islands 154. The passivation layer 180 may be made of an organic insulator such as silicon nitride and silicon oxide. The thickness of the passivation layer 180 may be from about 1,500 Å to about 2,500 Å.

The passivation layer 180 has a plurality of contact holes 182 exposing the end portions 179 of the data lines 171. The passivation layer 180 and the gate insulating layer 140 have a plurality of contact holes 181 exposing the end portions 129 of the gate lines 121 and a contact hole 186 exposing the common electrode line 126.

A common electrode 131 and a plurality of contact assistants 81 and 82 are formed on the passivation layer 180. The common electrode 131 and the contract assistants 81 and 82 are made of, for example, a transparent conductor such as polycrystalline, single-crystalline, or amorphous ITO or IZO. Alternatively, the common electrode 131 and the contact assistants 81 and 82 may be made of, for example, a reflective conductor such as Ag, Al, Cr, or alloys thereof.

The common electrode 131 includes a plurality of unit electrodes 135, a plurality of connecting portions 132, and an extension 139.

Like the pixel electrodes 191, the unit electrodes 135 of the common electrode 131 occupy most of the areas enclosed by the gate lines 121 and the data lines 171. In addition, the entire area or substantially the entire area of the unit electrodes 135 overlap the pixel electrodes 191.

Each of the unit electrodes 135 has a plurality of cutouts 133 defining a plurality of branch electrodes 134 and overlapping a pixel electrode 191. The cutouts 133 and the branch electrodes 134 extend substantially in the transverse direction, but make an oblique angle with the gate lines 121. Referring to FIG. 1, for example, the cutouts 133 and the branch electrodes 134 are arranged symmetrical with respect to a center transverse line bisecting the unit electrode 135 into upper and lower halves. The cutouts 133 and the branch electrodes 134 in the upper half of the unit electrode 135 are substantially parallel to each other, and similarly, those in the lower half of the unit electrode 135 are substantially parallel to each other. Accordingly, the cutouts 133 and the branch electrodes 134 in the upper half and the lower half of the unit electrode 135 make an oblique angle.

The connecting portions 132 of the common electrode 131 cross over the gate lines 121 and the data lines 171 to connect adjacent unit electrodes 135 in upper and lower and left and right directions.

The extension 139 of the common electrode 131 is connected to the common voltage line 126 through the contact hole 186 such that the common electrode 131 receives the common voltage from the common voltage line 126.

Each of the unit electrodes 135 of the common electrode 131 supplied with the common voltage generate an electric field in cooperation with a pixel electrode 191 supplied with a data voltage. Therefore, both the unit electrodes 135 and the pixel 191 are referred to as “field generating electrodes.” The electric field has both a vertical component perpendicular to the surface of the TFT array panel and a horizontal component parallel to the surface of the TFT array panel and perpendicular to edges of the cutouts 133 and the branch electrodes 134.

The horizontal component of the electric field may rotate liquid crystal molecules (not shown) on a plane parallel to the surface of the TFT array panel. The liquid crystal molecules are contained in a liquid crystal layer (not shown) disposed on the field generating electrodes 135 and 191. On the other hand, the vertical component of the electric field may tilt the liquid crystal molecules up or down. The orientations of the liquid crystal molecules determined by the electric field in turn determine the polarization of light passing through the liquid crystal layer, thereby determining the light transmittance.

Since the long axes of the liquid crystal molecules are distributed in multiple directions, the reference viewing angle of the LCD including the TFT array panel is wide. In addition, since both the horizontal component and the vertical component of the electric field contribute to displaying an image, the aperture ratio and the light transmittance of the LCD is relatively high, particularly for a transmissive LCD where the pixel electrodes 181 and the common electrode 131 including the branch electrodes 134 and the connecting portions 132 are transparent.

In addition, since only a thin passivation layer 180 having a thickness of about 2,000 Å is interposed between the common electrode 131 and the pixel electrodes 191, an electric field having a given strength is generated by a relatively low voltage as compared with a case that both the gate insulating layer 140 and the passivation layer 180 are interposed between the common electrode 131 and the pixel electrodes 191, thereby reducing the cost of driving integrated circuits for the LCD.

A pixel electrode 191 and a unit electrode 135 form a “liquid crystal capacitor” including the liquid crystal layer as a dielectric and also form a “storage capacitor” including the passivation layer 180 as a dielectric, which store applied voltages after the TFT turns off.

As a an alternative to being formed in the shape of a rectangle, each of the pixel electrodes 191 may be formed as bands disposed in the cutouts 133 of a unit electrode 135 and occupying a majority of the area of each cutout 133.

The contact assistants 81 and 82 are connected to the end portions 129 of the gate lines 121 and the end portions 179 of the data lines 171 through the contact holes 181 and 182, respectively. The contact assistants 81 and 82 protect the end portions 129 and 179 and enhance the adhesion between the end portions 129 and 179 and external devices.

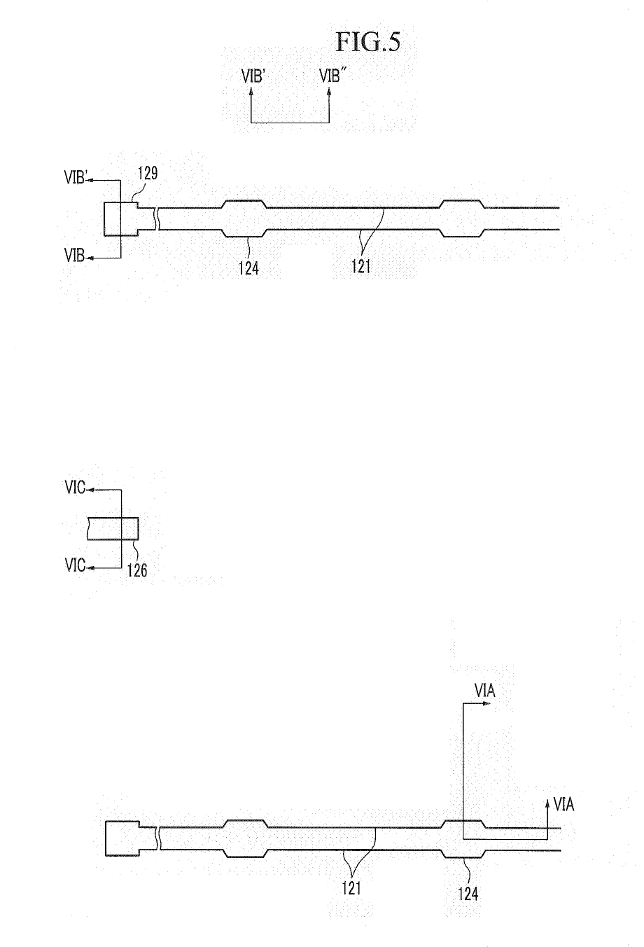

A method of manufacturing the TFT array panel shown in FIGS. 1-4 according to an embodiment of the present invention will be described with reference to FIGS. 5-14C as well as FIGS. 1-4.

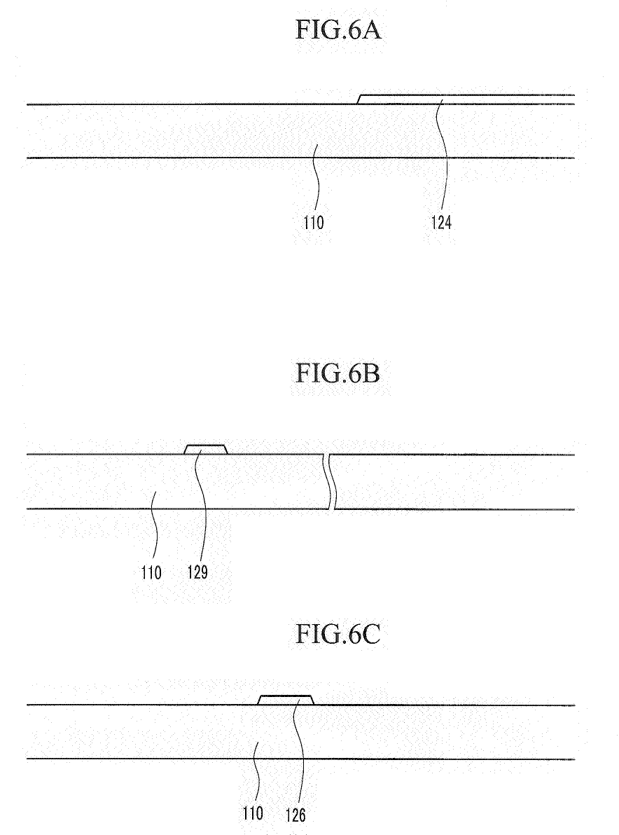

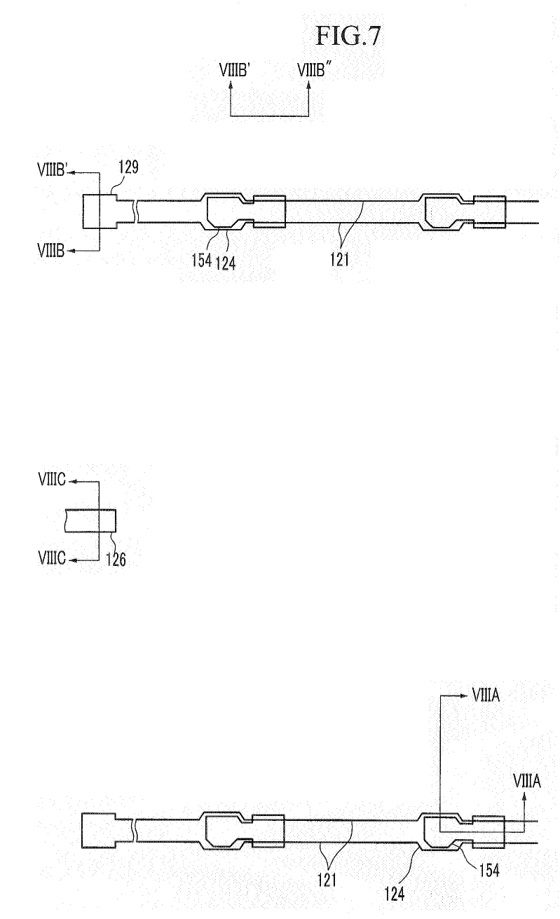

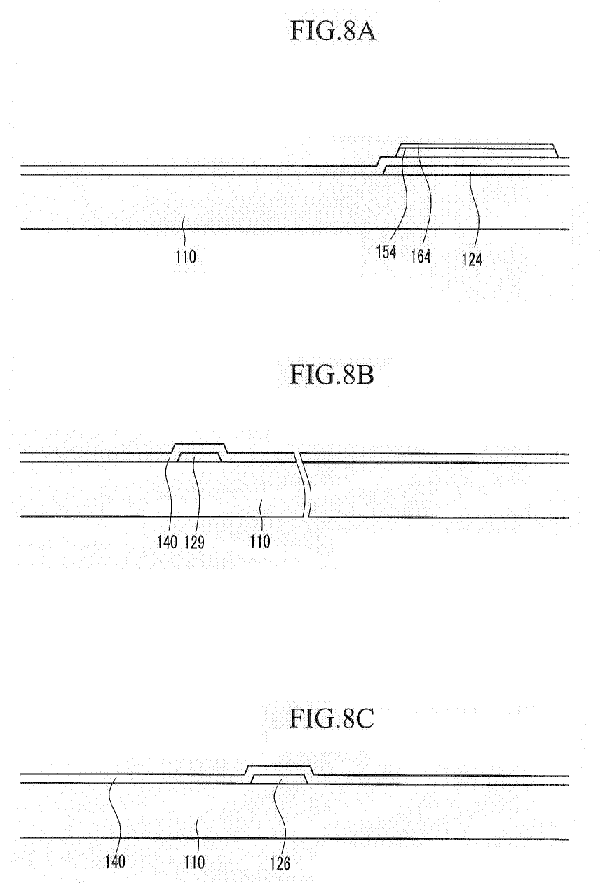

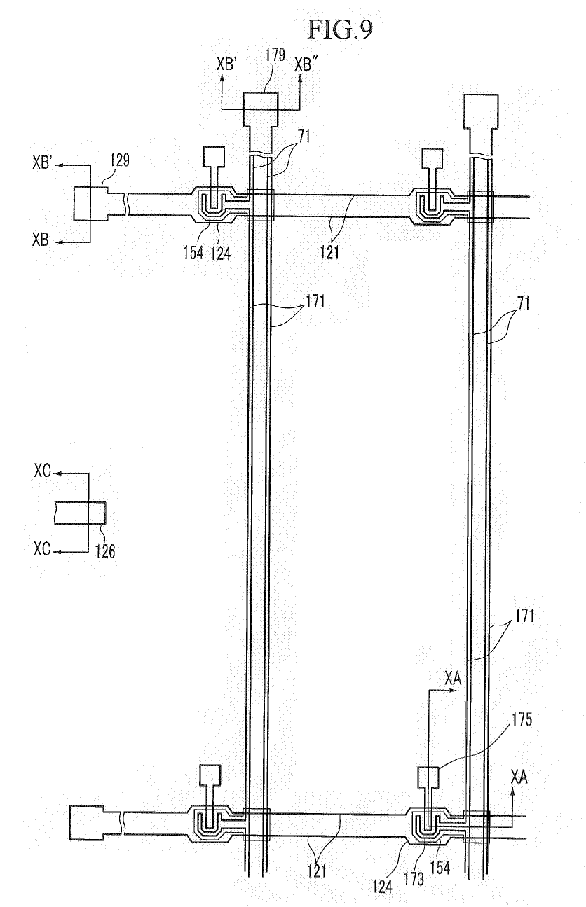

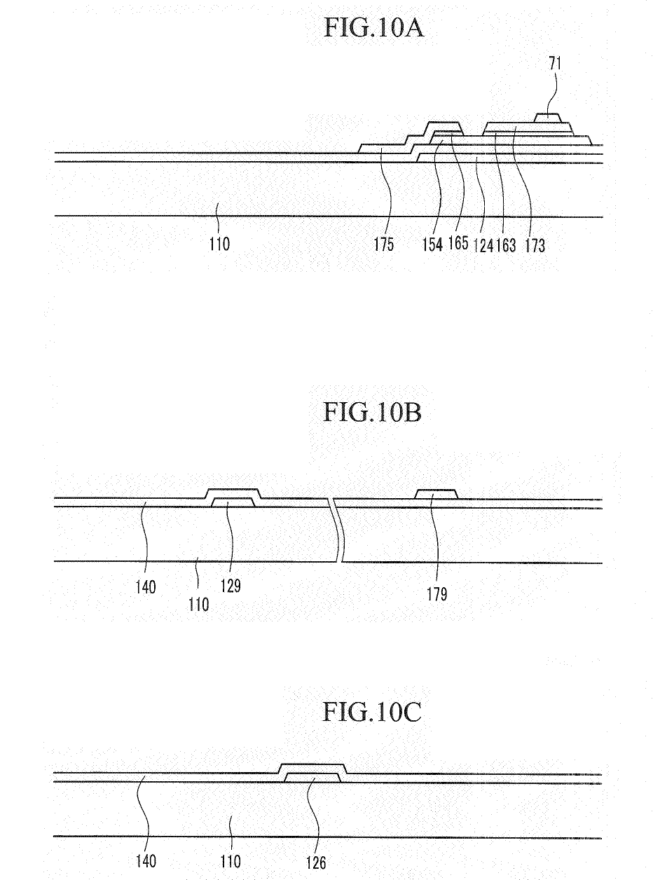

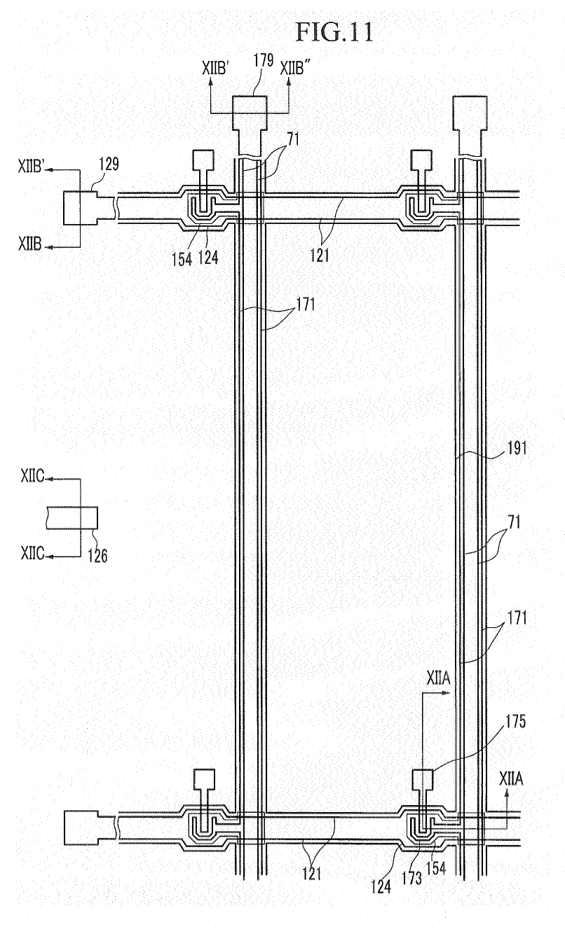

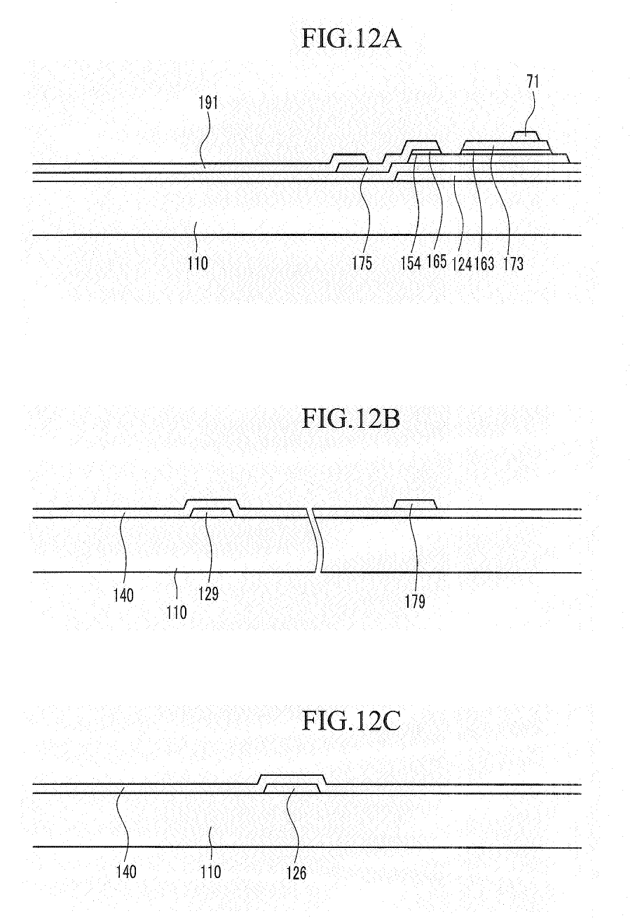

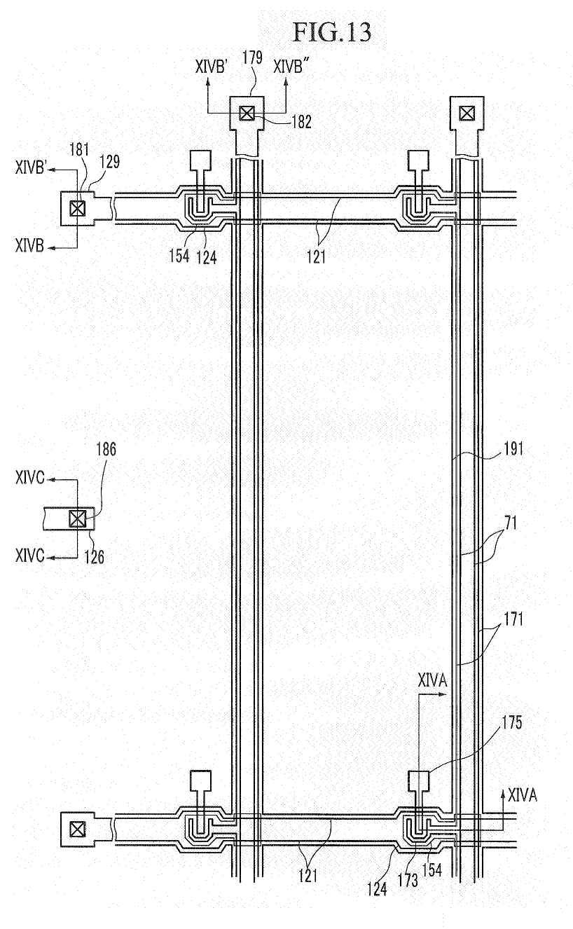

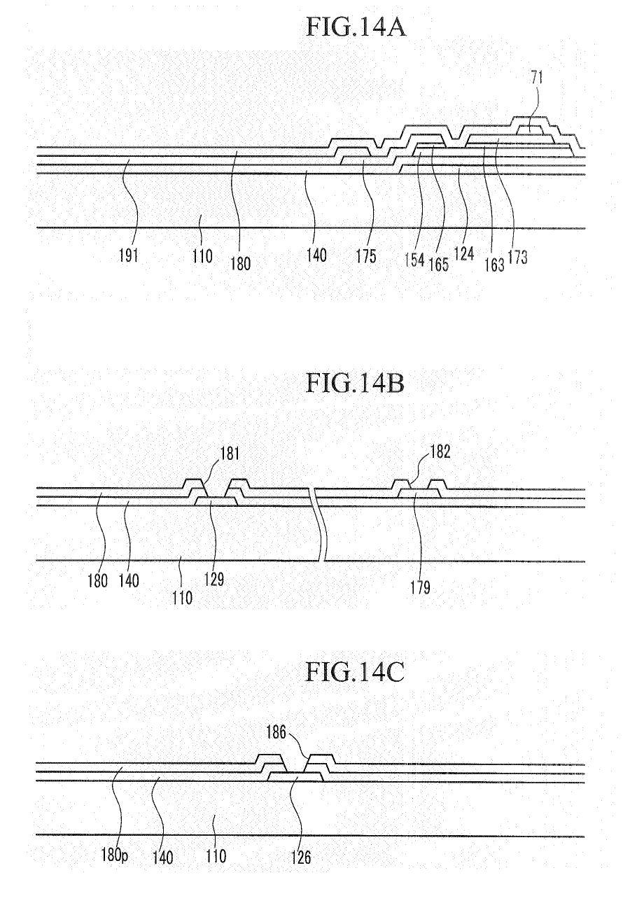

FIGS. 5, 7, 9, 11 and 13 are layout views of the TFT array panel shown FIGS. 1-4 during a manufacturing method thereof according to an embodiment of the present invention. FIGS. 6A-6C are sectional views of the TFT array panel shown in FIG. 5. FIGS. 8A-8C are sectional views of the TFT array panel shown in FIG. 7. FIGS. 10A-10C are sectional views of the TFT array panel shown in FIG. 9. FIGS. 12A-12C are sectional views of the TFT array panel shown in FIG. 11. FIGS. 14A-14C are sectional views of the TFT array panel shown in FIG. 13.

Referring to FIGS. 5-6C, a conductive layer is deposited on an insulating substrate 110 by sputtering, for example, and patterned by lithography and etching to form a plurality of gate lines 121 including gate electrodes 124 and end portions 129 and a common voltage line 126.

A gate insulating layer 140 having a thickness ranging from about 1,500 Å to about 5,000 Å, an intrinsic amorphous silicon layer having a thickness ranging from about 500 Å to about 2,000 Å, and an extrinsic amorphous silicon layer having a thickness ranging from about 300 Å to about 600 Å are sequentially deposited. The extrinsic and intrinsic amorphous silicon layers are patterned by lithography and etching to form a plurality of extrinsic semiconductor islands 164 and a plurality of intrinsic semiconductor islands 154 as shown in FIGS. 7-8C.

Referring to FIGS. 9-10C, a conductive layer having a thickness ranging from about 1,500 Å to about 3,000 Å is deposited by sputtering, for example, and patterned by lithography and etching to form a plurality of data lines 171 including source electrodes 173 and end portions 179 and the drain electrodes 175.

Thereafter, exposed portions of the extrinsic semiconductor strips 164, which are not covered with the data lines 171 and the drain electrodes 175, are removed to complete a plurality of ohmic contact islands 163 and 165 and to expose portions of the intrinsic semiconductor islands 154. Oxygen plasma treatment may follow in order to stabilize the exposed surfaces of the semiconductor islands 154.

Referring to FIGS. 11-12C, an ITO layer or an IZO layer is deposited by sputtering, for example, and patterned by lithography and etching to form a plurality of pixel electrodes 191 and a plurality of subsidiary data lines 71.

Referring to FIGS. 13-14C, an inorganic passivation layer 180 is deposited, and the passivation layer 180 and the gate insulating layer 140 are patterned by lithography and etching to form a plurality of contact holes 181, 182 and 186.

An ITO layer or an IZO layer is deposited on the passivation layer 180 by sputtering, for example, and patterned by lithography and etching to form a plurality of contact assistants 81 and 82 and a common electrode 131 including unit electrodes 135, connecting portions 132, and an extension 139.

Although exemplary embodiments of the present invention have been described hereinabove, it should be understood that the present invention is not limited to these embodiments, but may be modified by those skilled in the art without departing from the spirit and scope of the present invention, as defined in the appended claims.

What is claimed is:

1. A thin film transistor array panel comprising:
a substrate;
a gate line disposed on the substrate;
a gate insulating layer disposed on the gate line;
a semiconductor layer disposed on the gate insulating layer;
a data line contacting the semiconductor layer;
a drain electrode contacting the semiconductor layer, wherein the drain electrode is separated from the data line;
a pixel electrode disposed on the gate insulating layer and contacting the drain electrode;
a passivation layer disposed on the pixel electrode; and
a common electrode disposed on the passivation layer, wherein the common electrode includes a unit electrode overlapping the pixel electrode.

2. The thin film transistor array panel of claim 1, wherein the pixel electrode and the common electrode are substantially transparent.

3. The thin film transistor array panel of claim 2, wherein the pixel electrode and the unit electrode generate an electric field having a horizontal component and a vertical component.

4. The thin film transistor array panel of claim 2, wherein the unit electrode has a plurality of cutouts exposing the pixel electrode.

5. The thin film transistor array panel of claim 4, wherein the pixel electrode has a shape of a plane having no openings therein.

6. The thin film transistor array panel of claim 4, wherein the cutouts of the unit electrode fully overlap the pixel electrode.

7. The thin film transistor array panel of claim 4, wherein the cutouts of the unit electrode make oblique angles with the gate line.

8. The thin film transistor array panel of claim 7, wherein the cutouts of the unit electrode are arranged symmetrical with respect to a line substantially parallel to the gate line and bisecting the pixel electrode.

9. The thin film transistor array panel of claim 2, further comprising a subsidiary line contacting the data line and separated from the pixel electrode.

10. The thin film transistor array panel of claim 9, wherein the subsidiary line is formed from the same layer as the pixel electrode.

11. The thin film transistor array panel of claim 2, wherein the common electrode further includes a connecting portion connected to the unit electrode and intersecting at least one of the gate line and the data line.

12. The thin film transistor array panel of claim 2, further comprising a common voltage line formed from the same layer as the gate line or the data line and electrically connected to the common electrode.

13. A method of manufacturing a thin film transistor array panel, the method comprising:
forming a gate line on a substrate;
forming a gate insulating layer on the gate line;
forming a semiconductor layer on the gate insulating layer;
forming a data line and a drain electrode on the gate insulating layer and the semiconductor layer;
forming a pixel electrode on the drain electrode and the gate insulating layer;
forming a passivation layer on the pixel electrode; and
forming a common electrode on the passivation layer.

14. The method of claim 13, wherein the passivation layer has a thickness of about 1,500 Å to about 2,500 Å.

15. The method of claim 13, further comprising:
forming a common voltage line connected to the common electrode,
wherein the common voltage line and the gate line are simultaneously formed.

16. The method of claim 10, further comprising:
forming a subsidiary line on the data line,
wherein the subsidiary line and the pixel electrode are simultaneously formed.

17. The method of claim 13, wherein the common electrode has a plurality of cutouts exposing the pixel electrode.
